(19) United States
(12) Patent Application Publication
(10) Pub. No.: US 2026/0346574 A1
(43) Pub. Date: Nov. 5, 2026

(54) MULTILAYER LAMINATE COMPOSITE

(71) Applicant: MATERION CORPORATION, Mayfield Heights, OH (US)

(72) Inventors: Alyssa ELLIOTT, Mayfield Heights, OH (US); Fritz GRENSING, Mayfield Heights, OH (US); John NICKELL, Mayfield Heights, OH (US)

(73) Assignee: MATERION CORPORATION, Mayfield Heights, OH (US)

(21) Appl. No.: 19/487,705

(22) PCT Filed: May 30, 2024
(86) PCT No.: PCT/US2024/031551

§ 371 Date: Nov. 25, 2025

Related U.S. Application Data
(60) Provisional application No. 63/505,120, filed on May 31, 2023.

(51) Int. Cl. B32B 15/01; B32B 15/20; C22C 9/06; C22C 38/40; H01M 50/534

(52) U.S. Cl. CPC B32B 15/015; B32B 15/20; C22C 9/06; C22C 38/40; H01M 50/534

(57) ABSTRACT

A metallic laminate composite comprising a first layer comprising a copper-containing compound, a second layer selected from steel or stainless steel, and a third layer selected from copper or copper alloys. The second layer comprises 7 vol % to 25 vol % of the metallic laminate composite. In some cases, the composite the composite demonstrates a yield strength greater than 80 MPa.

### CROSS-REFERENCE TO RELATED APPLICATION

This application claims priority from U.S. Provisional Application No. 63/505,120 entitled “Multilayer Laminate Composite” filed May 31, 2023, the disclosure of which is incorporated herein by reference in its entirety.

### FIELD

The present disclosure provides a laminate composite having multiple layers of a metal or metal alloy. In particular the disclosure relates to a multilayer laminate composite that comprises a skin layer comprising a copper compound.

### BACKGROUND

Some multiple layer metallic laminate materials are known. These conventional laminates are often suitable for use as connectors in battery packs or in resistance welding applications.

For example, U.S. Pat. No. 10,707,472 discloses a multiple layer metallic laminate, in which the multiple layer laminate composite includes a first metallic layer having good soldering properties, such as commercially available nickel or nickel alloys, a second metallic layer having good resistance welding properties, such as commercial available steels or stainless steels, a third metallic layer having low electrical resistivity properties, such as commercially available copper and copper alloys, a fourth metallic layer having good resistance welding properties, such as commercially available steels or stainless steels, and a fifth metallic layer having good soldering properties, such as commercially available nickel or nickel alloys.

US 2010/0178559 discloses nickel-copper clad tabs for rechargeable battery negative electrodes and methods of manufacturing thereof. Systems and methods for configuring tabs on a rechargeable battery may include a current collector comprising one or more collector foil and one or more tabs connected to the collector foil for conveying generated current from the current collector. The tabs may be configured to extract greater capacity from the battery electrodes so that the resulting battery may exhibit higher performance. The tabs may be configured so that a negative electrode tab may be clad with a nickel layer and a copper layer.

Even in view of the known references relating to multilayer metallic laminates, a need exists for multilayer laminates that demonstrate improvements in soldering/welding performance while also providing improvements in corrosion resistance.

### SUMMARY

The present disclosure provides a metallic laminate composite comprising a first layer comprising a copper-containing compound; a second layer selected from steel or stainless steel; a third layer selected from copper or copper alloys; an optional fourth layer selected from steel or stainless steel; and an optional fifth layer comprising a copper-containing compound. The composite demonstrates a conductivity ranging from 40% IACS to 82% IACS, as determined by ASTM E1004, while the first layer of the multilayer laminate has a conductivity of less than 10% IACS. The metallic laminate composite further demonstrates excellent corrosion resistance, as determined by SAE/USCAR2 5.6.2 and ASTM B117.

The copper-containing compound may be copper, a copper alloy such as a copper-nickel alloy or copper-nickel-tin alloy, or a combination thereof. More specifically, in the case of a copper alloy, such as a copper-nickel alloy, copper is present in an amount ranging from 60 wt. % to 95 wt. % copper and nickel is present in an amount ranging from 5 wt. % to 40 wt. % nickel, such as greater than 5 wt. % and less than 35 wt. %.

In some embodiments, the first layer comprises 0.9 vol % to 10 vol % of the laminate composite; the second layer comprises 7 vol % to 25 vol % of the laminate composite; the third layer comprises 40 vol % to 80 vol % of the laminate composite; the fourth layer comprises 7 vol % to 25 vol % of the laminate composite; and/or the fifth layer comprises 0.9 vol % to 10 vol % of the laminate composite. In these embodiments, annealed metallic laminate composite demonstrates a tensile modulus ranging from 120 GPa to 180 MPa, a yield strength greater than 80 MPa, and/or a flexural modulus greater than 135 GPa.

In some embodiments, the first layer comprises 0.7 vol % to 1.4 vol % of the laminate composite; the second layer comprises 7 vol % to 25 vol % of the laminate composite; the third layer comprises 40 vol % to 80 vol % of the laminate composite; the fourth layer comprises 7 vol % to 25 vol % of the laminate composite; and/or the fifth layer comprises 0.7 vol % to 1.4 vol % of the laminate composite, and the laminate composite demonstrates a flexural strength of greater than 62 MPa.

The metallic laminate composite may be used as a connector tab for a pack of lithium ion batteries.

### BRIEF DESCRIPTION OF THE DRAWING

FIG. 1 shows the multilayer laminate composite disclosed herein.

### DETAILED DESCRIPTION

### Introduction

As noted above, conventional laminate materials often employ as a skin layer such as nickel or nickel alloys. These metals/alloys are known to be expensive and potentially toxic. These materials may also have high thermal conductivity, which may detrimentally allow heat to very readily spread over the surface. This may limit their ability to perform effectively for resistance welding as heat is dispersed over the surface area. In addition, conventional laminate materials, because of the metallurgy of the skin layers thereof, have been found to suffer from corrosion resistance problems as well as potential toxicity issues. And in specific applications such as connector tabs in battery packs, these materials may cause degradation of battery performance and safety due to resistive heating, particularly when used in higher power applications.

It has now been discovered that the use of the lower thermal conductivity metals (as a skin layer), and particular metals in a second layer, both in particular volume percentages, provides a synergistic combination of performance features, e.g., improved, (resistance) welding and/or soldering performance and decreased toxicity along with superior yield strength performance, optionally in conjunction with cost benefits.

It has been shown that selected layers provide surprising benefits when present in particular volume percentages. Specifically, when the second layer is present in a volume lower than 7 vol % of the entire laminate composite, yield strength suffers even if solderability is maintained. The disclosed percentages contribute to the aforementioned combination of benefits, e.g., solderability and yield strength.

The inventors have now found that certain (non-nickel) metals and/or metal alloys, e.g., copper or copper alloys, are surprisingly effective when employed in multilayer laminate materials, e.g., as a skin layer. In some cases, the use of lower thermal conductivity metals or alloys provides for a multilayer laminate that demonstrates a synergistic combination of performance and chemical/metallurgical properties. For example and as noted above, the multilayer laminate materials may demonstrate an improved ability to weld and/or solder, e.g., to resistance weld, as well as unexpected corrosion resistance performance. Without being bound by theory, it is postulated that, in use, the lower thermal conductivity metals allow heat (from a welding or soldering operation) to be more localized. That is to say, the lower thermal conductivity metals focus heat in a precisely defined area, which leads to improvements in weldability. In contrast, conventional laminates allow heat to disperse much more readily, which is highly detrimental to welding or soldering operations. And, because of the metallurgy of the skin layer, corrosion resistance is also improved (versus conventional nickel skin layers).

Further, it has been discovered that, when the aforementioned copper or copper alloy layers are employed, the resultant laminate demonstrates a surprising improvement in yield strength, versus conventional laminates, e.g., those that employ nickel or nickel alloys in the skin layer.

Thus, the multilayer laminate composites disclosed herein provide significant advantages in cost, yield strength, weldability, solderability, and corrosion resistance, while continuing to demonstrate the desirable properties of known materials.

### Multilayer Composite

The disclosure relates to multilayer laminate composite that comprises a first layer (skin layer), a second layer (welding layer), and a third layer (conductivity layer). In some cases, the multilayer laminate composite comprises a first metallic layer comprising copper or copper alloys, a second metallic layer comprising steel or stainless steel, and a third metallic layer comprising copper or copper alloys. In some embodiments, an optional fourth metallic layer comprising steel or stainless steel and/or an optional fifth metallic layer comprising copper or copper alloys are employed. In some embodiments, the first metallic layer comprises greater than 0.9 vol % of the multilayer laminate composite, and the second metallic layer comprises greater than 7 vol % of the multilayer laminate composite. In some embodiments, the first metallic layer comprises from 0.7 vol % to 1.4 vol % of the multilayer laminate composite, and the second metallic layer comprises greater than 7 vol % of the multilayer laminate composite.

The multilayer laminate composite beneficially demonstrates improved welding and/or soldering performance. For example, the multilayer composite may require lower weld force and shorter weld time than conventional materials while withstanding a higher peak weld current.

In some cases, the multilayer composite may (in addition to the welding/soldering performance) demonstrate improved electrical conductivity, e.g., conductivity ranging from 40% to 82% IACS as measured by ASTM E1004, e.g., from 41% to 81%, from 42% to 80%, from 43% to 79%, from 44% to 78%, from 45% to 77%, from 46% to 76%, from 47% to 75%, from 48% to 74%, from 49% to 73%, from 50% to 72%, from 51% to 71%, from 52% to 70%, from 53% to 69%, from 54% to 68%, from 55% to 67%, from 56% to 66%, from 57% to 65%, from 58% to 64%, from 59% to 63%, or from 60% to 62%. In terms of upper limits, the conductivity of the multilayer metallic laminate composite may be less than 82%, e.g., less than 81%, less than 80%, less than 79%, less than 78%, less than 77%, less than 76%, less than 75%, less than 74%, less than 73%, less than 72%, less than 71%, less than 70%, less than 69%, less than 68%, less than 67%, less than 66%, less than 65%, less than 64%, less than 63%, less than 62%, or less than 61%. In terms of lower limits, the conductivity of the multilayer metallic laminate composite may be greater than 40% greater than 41%, greater than 42%, greater than 43%, greater than 44%, greater than 45%, greater than 46%, greater than 47%, greater than 48%, greater than 49%, greater than 50%, greater than 51%, greater than 52%, greater than 53%, greater than 54%, greater than 55%, greater than 56%, greater than 57%, greater than 58%, greater than 59%, or greater than 60%.

The multilayer composite may demonstrate excellent resistance to corrosion in comparison to conventional materials. Corrosion resistance may be measured by SAE/USCAR2 5.6.2 and ASTM B117, for example. Additionally, the multilayer composite may demonstrate superior resistance to discoloration. Other performance characteristics are discussed in detail below.

The layers may be configured together, e.g., bonded together, to form the multilayer composite. In some cases, the first and optional fifth layers may be configured as skin layers, e.g., external layers, and the second and optional fourth layers may be configured as internal layers and may abut the first and optional fifth layers, respectively. The third layer may be sandwiched between the second and optional fourth layers.

The layers may be configured together using known techniques and these techniques may vary widely. Exemplary methods include roll bonding, cold roll bonding, hot roll bonding, or circumferential welding of ingots, billets, or slabs or combinations of these methods (optionally followed by cold-hot rolling). Other techniques include adhesive bonding, diffusion bonding, cold roll bonding, explosion bonding, electrodepositing of one layer onto a substrate of a second layer, or flame spraying of one layer onto a substrate of another layer.

### First Layer

The first layer comprises copper-containing compounds, such as copper and/or copper alloys. The use of these metals in the skin layer advantageously improves welding and/or soldering performance (versus conventional laminates that utilize nickel skin layers). Conventional laminates require nickel or nickel alloys as skin layers, which contributes to poor performance, see discussion above. Conventional copper skin layers may demonstrate electrical conductivity values in excess of 100% IACS, and conventional nickel skin layers may demonstrate electrical conductivity values of 18% IACS. Advantageously, the first layers disclosed herein may demonstrate lower electrical conductivity, e.g., less than 15% IACS as measured by ASTM E1004; e.g., less than 14% IACS, less than 13% IACS, less than 12% IACS, less than 11% IACS, less than 10% IACS, less than 9% IACS, less than 8% IACS, less than 7% IACS, less than 6% IACS, or less than 5% IACS. In use, the employment of the disclosed first layers, e.g., layers of copper-containing compounds, contribute to the aforementioned synergistic combination of performance features. The second and third layers (as well as optional fourth and fifth layers) are discussed in detail below.

The first layer may comprise copper or a copper alloy. When the first layer comprises a copper alloy, the copper alloy may comprise copper in an amount from 50 wt. % to 95 wt. %, e.g., from 51 wt. % to 95 wt. %, from 55 wt. % to 90 wt. %, from 60 wt. % to 85 wt. %, from 65 wt. % to 80 wt. %, or from 70 wt. % to 75 wt. %. In terms of upper limits, the alloy may comprise copper in an amount of less than 95 wt. %, e.g., less than 90 wt. %, less than 85 wt. %, or less than 80 wt. %. In terms of lower limits, the copper alloy may comprise copper in an amount of greater than 50 wt. %, e.g., of greater than 51 wt. %, greater than 55 wt. %, greater than 60 wt. %, greater than 65 wt. %, greater than 70 wt. %, or greater than 75 wt. %. The copper alloy may also contain secondary metals, e.g., nickel, and these secondary metals would make up the remainder of the composition of the alloy.

In some cases, the copper alloy may be comprised of a copper-nickel based alloy, including, but not limited to: cupronickel alloys, nickel silver alloys, and/or copper-nickel-tin alloys. Suitable commercially-available copper alloys include, for example, C70600, C71500, C71640, C702500, C702600, C72500, C72900, C73500, C75200, C76200, C77000.

The first layer may comprise from 0.9 vol % to 10 vol % of the entire laminate composite, e.g., from 1.0 vol % to 9 vol %, from 1.1 vol % to 8 vol %, from 1.2 vol % to 7 vol % from 1.3 vol % to 6 vol %, from 1.4 vol % to 5 vol %, from 1.5 vol % to 4 vol %, from 1.6 vol % to 3 vol %, from 1.7 vol % to 2 vol %, or from 1.8 vol % to 1.9 vol %. In terms of upper limits, the first layer may comprise less than 10 vol % of the entire laminate composite, e.g., less than 9 vol %, less than 8 vol %, less than 7 vol %, less than 6 vol %, less than 5 vol %, less than 4 vol %, less than 3 vol %, less than 2 vol %, or less than 1.9 vol %. In terms of lower limits, the first layer may comprise greater than 0.9 vol % of the entire laminate composite, e.g., greater than 1.0 vol %, greater than 1.1 vol %, greater than 1.2 vol %, greater than 1.3 vol %, greater than 1.4 vol %, greater than 1.5 vol %, greater than 1.6 vol %, greater than 1.7 vol %, or greater than 1.8 vol %.

Alternatively, the first layer may comprise from 0.7 vol % to 1.4 vol % of the entire laminate composite, e.g., from 0.8 vol % to 1.3 vol %, from 0.9 vol % to 1.2 vol %, or from 1.0 vol % to 1.1 vol %. In terms of upper limits, the first layer may comprise less than 1.4 vol % of the entire laminate composite, e.g., less than 1.3 vol %, less than 1.2 vol %, or less than 1.1 vol %. In terms of lower limits, the first layer may comprise greater than 0.7 vol %, e.g., greater than 0.8 vol %, greater than 0.9 vol %, or greater than 1.0 vol %.

In some cases, the first layer contributes to improved weldability. Suitability for welding may be determined by the tendency of the weld to crack, the thermal expansion of the material, and the thermal conductivity of the material, for example. The overall weldability of the material is rated herein on a scale of 1 to 5, with 1 indicating poor weldability and 5 indicating excellent weldability. Additionally or alternatively, weldability may be measured by the pull strength of the bond.

In cases where a copper-nickel alloy is contemplated, the copper-nickel alloy or copper-nickel-tin alloy comprises copper in the amounts mentioned above, and nickel in an amount ranging from 5 wt. % to 40 wt. %, e.g., from 6 wt. % to 39 wt. %, from 7 wt. % to 38 wt. %, from 8 wt. % to 37 wt. %, from 9 wt. % to 36 wt. %, from 10 wt. % to 35 wt. %, from 11 wt. % to 34 wt. %, from 12 wt. % to 33 wt. %, from 13 wt. % to 32 wt. %, from 14 wt. % to 31 wt. %, from 15 wt. % to 30 wt. %, from 16 wt. % to 29 wt. %, from 17 wt. % to 28 wt. %, from 18 wt. % to 27 wt. %, from 19 wt. % to 26 wt. %, from 20 wt. % to 25 wt. %, from 21 wt. % to 24 wt. %, or from 22 wt. % to 23 wt. %. In terms of upper limits, the amount of nickel may be less than 40 wt. %, e.g., less than 39 wt. %, less than 38 wt. %, less than 37 wt. %, less than 36 wt. %, less than 35 wt. %, less than 34 wt. %, less than 33 wt. %, less than 32 wt. %, less than 31 wt. %, less than 30 wt. %, less than 29 wt. %, less than 28 wt. %, less than 27 wt. %, less than 26 wt. %, less than 25 wt. %, less than 24 wt. %, or less than 23 wt. %. In terms of lower limits, the amount of nickel may be greater than 5 wt. %, e.g., greater than 6 wt. %, greater than 7 wt. %, greater than 8 wt. %, greater than 9 wt. %, greater than 10 wt. %, greater than 11 wt. %, greater than 12 wt. %, greater than 13 wt. %, greater than 15 wt. %, greater than 16 wt. %, greater than 17 wt. %, greater than 18 wt. %, greater than 19 wt. %, greater than 20 wt. %, greater than 21 wt. %, or greater than 22 wt. %.

In cases where a copper-nickel-tin alloy is contemplated, the copper-nickel-tin alloy comprises tin in an amount less than 10 wt. %, e.g., less than 9 wt. %, less than 8 wt. %, less than 7 wt. %, less than 6 wt. %, less than 5 wt. %, less than 4 wt. %, less than 3 wt. %, less than 2 wt. %, or less than 1 wt. %.

The copper-nickel alloy or copper-nickel-tin alloy may further comprise iron in an amount less than 2.0 wt. %, e.g., less than 1.9 wt. %, less than 1.8 wt. %, less than 1.7 wt. %, less than 1.6 wt. %, less than 1.5 wt. %, less than 1.4 wt. %, less than 1.3 wt. %, less than 1.2 wt. %, less than 1.1 wt. %, less than 1.0 wt. %, less than 0.9 wt. %, less than 0.8 wt. %, less than 0.7 wt. %, less than 0.6 wt. %, less than 0.5 wt. %, less than 0.4 wt. %, less than 0.3 wt. %, less than 0.2 wt. %, less than 0.1 wt. %, less than 900 ppm, less than 800 ppm, less than 700 ppm, less than 600 ppm, less than 500 ppm, less than 400 ppm, less than 300 ppm, less than 200 ppm, or less than 100 ppm.

The copper-nickel alloy or copper-nickel-tin alloy may further comprise zinc in an amount ranging from 1 wt. % to 40 wt. %, e.g., from 5 wt. % to 35 wt. %, from 10 wt. % to 30 wt. %, or from 15 wt. % to 25 wt. %. In terms of upper limits, the amount of zinc may be less than 40 wt. %, e.g., less than 35 wt. %, less than 30 wt. %, less than 25 wt. %, or less than 20 wt. %. In terms of lower limits, the amount of zinc may be greater than 1 wt. %, e.g., greater than 5 wt. %, greater than 10 wt. %, or greater than 15 wt. %.

The copper-nickel alloy or copper-nickel-tin alloy may further comprise manganese in an amount less than 1000 ppm e.g., less than 900 ppm, less than 800 ppm, less than 700 ppm, less than 600 ppm, less than 500 ppm, less than 400 ppm, less than 300 ppm, less than 200 ppm, or less than 100 ppm.

In some cases, the first layer contributes to the improved ability to solder. Suitability for soldering may be determined by the ability of the layer to be wetted by the molten solder. The overall solderability of the material is rated herein on a scale of 1 to 5, with 1 indicating poor solderability and 5 indicating excellent solderability. Solderability may be tested to comply with the standards described in IPC/ANSI-J-STD002 and IEC 60068-2-54, for example.

### Second Layer

In some cases, the second layer may contribute to the ability to resistance weld. Suitability for resistance welding may be determined, in part, by the compatibility of thermal properties and melting characteristics of the systems to be welded together. Without wishing to be bound by theory, such compatibility may help to limit the formation of brittle metallic phases as the weld site.

The second layer may comprise from 7 vol % to 25 vol % of the entire laminate composite, e.g., from 8 vol % to 24 vol %, from 9 vol % to 23 vol %, from 10 vol % to 22 vol %, from 11 vol % to 21 vol %, from 12 vol % to 20 vol %, from 13 vol % to 19 vol %, from 14 vol % to 18 vol %, or from 15 vol % to 17 vol %. In terms of upper limits, the second layer may comprise less than 25 vol % of the entire laminate composite, e.g., less than 24 vol %, less than 23 vol %, less than 22 vol %, less than 21 vol %, less than 20 vol %, less than 19 vol %, less than 18 vol %, less than 17 vol %, or less than 16 vol %. In terms of lower limits, the second layer may comprise greater than 7 vol % of the entire laminate composite, e.g., greater than 8 vol %, greater than 9 vol %, greater than 10 vol %, greater than 11 vol %, greater than 12 vol %, greater than 13 vol %, greater than 14 vol %, or greater than 15 vol %.

The second layer may comprise steel or stainless steel. The stainless steel may comprise chromium in an amount from 10 wt. % to 25 wt. %, such as 11 wt. % to 24 wt. %, 12 wt. % to 23 wt. %, 13 wt. % to 22 wt. %, 14 wt. % to 21 wt. %, 15 wt. % to 20 wt. %, 16 wt. % to 19 wt. %, or 17 wt. % to 18 wt. %. In terms of upper limits, the stainless steel may comprise chromium in an amount less than 25 wt. %, e.g., less than 24 wt. %, less than 23 wt. %, less than 22 wt. %, less than 21 wt. %, less than 20 wt. %, less than 19 wt. %, or less than 18 wt. %. In terms of lower limits, the stainless steel may comprise chromium in an amount of greater than 10 wt. %, e.g., greater than 11 wt. %, greater than 12 wt. %, greater than 13 wt. %, greater than 14 wt. %, greater than 15 wt. %, greater than 16 wt. %, or greater than 17 wt. %.

The stainless steel may comprise nickel in an amount from 0 wt. % to 12 wt. %, e.g., from 1 wt. % to 11 wt. %, from 2 wt. % to 10 wt. %, from 3 wt. % to 9 wt. %, from 4 wt. % to 8 wt. %, or from 5 wt. % to 7 wt. %. In terms of upper limits, the stainless steel may comprise nickel in an amount less than 12 wt. %, e.g., less than 11 wt. %, less than 10 wt. %, less than 9 wt. %, less than 8 wt. %, less than 7 wt. %, or less than 6 wt. %. In terms of lower limits, the stainless steel may comprise nickel in an amount greater than 0 wt. %, e.g., greater than 1 wt. %, greater than 2 wt. %, greater than 3 wt. %, greater than 4 wt. %, or greater than 5 wt. %.

Suitable stainless steel compositions may include S430, S304, S305, and S316, for example.

It has been observed that, when the second layer comprises less than 7 vol % of the laminate composite, performance characteristics, e.g., yield strength, may suffer.

### Third Layer

The third layer may display high electrical conductivity. Specifically, the electrical conductivity of the third layer may be from 100 to 102% IACS.

The third layer may comprise from 40 vol % to 80 vol % of the laminate composite, e.g., from 45 vol % to 75 vol %, from 50 vol % to 70 vol %, or from 55 vol % to 65 vol %. In terms of upper limits, the third layer may comprise less than 80 vol % of the laminate composite, e.g., less than 75 vol %, less than 70 vol %, less than 65 vol %, or less than 60 vol %. In terms of lower limits, the third layer may comprise greater than 40 vol % or the laminate composite, e.g., greater than 45 vol %, greater than 50 vol %, or greater than 55 vol %.

The third layer may comprise copper in an amount of greater than 90 wt. %, e.g., greater than 91 wt. %, greater than 92 wt. %, greater than 93 wt. %, greater than 94 wt. %, greater than 95 wt. %, greater than 96 wt. %, greater than 97 wt. %, greater than 98 wt. %, greater than 99 wt. %, greater than 99.5 wt. %, or greater than 99.9 wt. %. Suitable copper compositions may include C10200, C10700, and C11000, for example.

### Fourth Layer

The optional fourth layer may be similar or identical in composition and amount to the second layer, as described above. For example, the optional fourth layer may also comprise steel or stainless steel. In one embodiment, the second and fourth layers are the same. In one embodiment, the second and fourth layers differ.

As the second layer is suitable for resistance welding, a suitable fourth layer will also be suitable for resistance welding.

### Fifth Layer

The optional fifth layer may be similar or identical in composition and amount to the first layer, as described above. For example, the optional fifth layer may also comprise copper or a copper alloy. In one embodiment, the first and fifth layers are the same. In one embodiment, the first and fifth layers differ.

As the first layer is suitable for soldering, a suitable fifth layer will also be suitable for soldering.

### Performance Characteristics

The tensile strength of the annealed multilayer composite may range from 200 MPa to 430 MPa as measured by ASTM E8, e.g., from 210 MPa to 420 MPa, from 220 MPa to 410 MPa, from 230 MPa to 400 MPa, from 240 MPa to 390 MPa, from 250 MPa to 380 MPa, from 260 MPa to 370 MPa, from 270 MPa to 360 MPa, from 280 MPa to 350 MPa, from 290 MPa to 340 MPa, from 300 MPa to 330 MPa, or from 310 MPa to 320 MPa. In terms of upper limits, the tensile strength of the multilayer composite may be less than 430 MPa, e.g., less than 420 MPa, less than 410 MPa, less than 400 MPa, less than 390 MPa, less than 380 MPa, less than 370 MPa, less than 360 MPa, less than 350 MPa, less than 340 MPa, less than 330 MPa, or less than 320 MP. In terms of lower limits, the tensile strength of the multilayer composite may be greater than 200 MPa, e.g., greater than 210 MPa, greater than 220 MPa, greater than 230 MPa, greater than 240 MPa, greater than 250 MPa, greater than 260 MPa, greater than 270 MPa, greater than 280 MPa, greater than 290 MPa, greater than 300 MPa, or greater than 310 MPa. In some embodiments, the tensile strength of the multilayer composite may range from 350 MPa to 420 MPa.

The tensile modulus of the annealed multilayer composite may range from 120 GPa to 180 GPa, e.g., from 125 GPa to 175 GPa, from 130 GPAa to 170 GPa, from 135 GPa to 165 GPa, from 140 GPa to 160 GPa, or from 145 GPa to 155 GPa. In terms of upper limits, the tensile modulus of the multilayer composite may be less than 180 GPa, e.g., less than 175 GPa, less than 170 Pa, less than 165 GPa, less than 160 GPA, less than 155 GPa, or less than 150 GPa. In terms of lower limits, the tensile modulus of the multilayer composite may be greater than 120 GPa, e.g., greater than 125 GPa, greater than 130 GPa, greater than 135 GPa, greater than 140 GPa, or greater than 145 GPa.

In some cases, such as when the first layer comprises greater than 0.9 vol % of the entire laminate composite, the yield strength of the annealed multilayer composite may be range from 80 MPa to 180 MPa, as measured by ASTM E8, e.g., from 85 MPa to 175 MPa, from 90 MPa to 170 MPa, from 95 MPa to 165 MPa, from 100 MPa to 160 MPa, from 105 MPa to 155 MPa, from 110 MPa to 150 MPa, from 115 MPa to 145 MPa, from 120 MPa to 140 MPa, or from 125 MPa to 135 MPa. In terms of upper limits, the yield strength of the annealed multilayer composite may be less than 180 MPa, e.g., less than 175 MPa, less than 170 MPa, less than 165 MPa, less than 160 MPa, less than 155 MPa, less than 150 MPa, less than 145 MPa, less than 140 MPa, less than 135 MPa, or less than 130 MPa. In terms of lower limits, the yield strength of the multilayer composite may be greater than 80 MPa, e.g., greater than 85 MPa, greater than 90 MPa, greater than 95 MPa, greater than 100 MPa, greater than 105 MPa, greater than 110 MPa, greater than 115 MPa, greater than 120 MPa, or greater than 125 MPa.

In those cases wherein the first layer comprises from 0.7 vol % to 1.4 vol % of the entire multilayer composite, the yield strength of the annealed multilayer composite may range from 62 MPa to 80 MPa, e.g., from 63 MPa to 79 MPa, from 64 MPa to 78 MPa, from 65 MPa to 77 MPa, from 66 MPa to 76 MPa, from 67 MPa to 75 MPa, from 68 MPa to 74 MPa, from 69 MPa to 73 MPa, or from 70 MPa to 72 MPa. In terms of upper limits, the yield strength of the multilayer composite may be less than 80 MPa, e.g., less than 79 MPa, less than 78 MPa, less than 77 MPa, less than 76 MPa, less than 75 MPa, less than 74 MPa, less than 73 MPa, less than 72 MPa, or less than 71 MPa. In terms of lower limits, the yield strength of the multilayer composite may be greater than 62 MPa, e.g., greater than 63 MPa, greater than 64 MPa, greater than 65 MPa, greater than 66 MPa, greater than 67 MPa, greater than 68 MPa, greater than 69 MPa, greater than 70 MPa, or greater than 71 MPa.

The flexural modulus of the annealed multilayer composite may range from 135 GPa to 190 GPa, e.g., from 140 GPa to 185 GPa, from 145 GPa to 180 GPa, from 150 GPa to 175 GPa, from 155 to GPa to 170 GPa, or from 160 GPa to 165 GPa. In terms of upper limits, the flexural modulus of the annealed multilayer composite may be less than 190 GPa, e.g., less than 185 GPa, less than 180 GPa, less than 175 GPa, or less than 170 GPa, less than 165 GPa. In terms of lower limits, the flexural modulus of the annealed multilayer composite may be greater than 135 GPa, e.g., greater than 140 GPa, greater than 145 GPa, greater than 150 GPa, greater than 155 GPa, or greater than 160 GPa.

The elastic modulus of the multilayer composite may range from 100 GPa to 200 GPa, as calculated by using data measured from tensile tests per ASTM E8, e.g., from 110 GPa to 190 GPa, from 120 GPa to 180 GPa, from 130 GPa to 170 GPa, or from 140 GPa to 160 GPa. In terms of upper limits, the elastic modulus of the multilayer composite may be less than 200 GPa, e.g., less than 190 GPa, less than 180 GPa, less than 170 GPa, less than 160 GPa, or less than 150 GPa. In terms of lower limits, the elastic modulus of the multilayer composite may be greater than 100 GPa, e.g., greater than 110 GPa, greater than 120 GPa, greater than 130 GPa, or greater than 140 GPa.

The multilayer composite may demonstrate elongation at break ranging from 6% to 30%, e.g., from 7% to 29%, from 8% to 28%, from 9% to 27%, from 10% to 26%, from 11% to 25%, from 12% to 24%, from 13% to 23%, from 14% to 22%, from 15% to 21%, from 16% to 20%, or from 17% to 19%. In terms of upper limits, the multilayer composite may demonstrate elongation at break less than 29%, less than 28%, less than 27%, less than 26%, less than 25%, less than 24%, less than 23%, less than 22%, less than 21%, less than 20%, less than 19%, or less than 18%. In terms of lower limits, the multilayer composite may demonstrate elongation at break greater than 8%, greater than 9%, greater than 10%, greater than 11%, greater than 12%, greater than 13%, greater than 14%, greater than 15%, greater than 16%, or greater than 17%.

The multilayer composite may demonstrate a bending radius of less than 0.002 inches GW/BW, e.g., less than 0.0015 inches, less than 0.001 inches, less than 0.0009 inches, less than 0.0008 inches, less than 0.0007 inches, less than 0.0006 inches, less than 0.0005 inches, less than 0.0004 inches, less than 0.0003 inches, less than 0.0002 inches, or less than 0.0001 inches.

The thermal conductivity of the multilayer composite may range from 45 W/mK to 220 W/mK, e.g., from 50 W/mK to 210 W/mK, from 60 W/mK to 200 W/mK, from 70 W/mK to 190 W/mK, from 80 W/mK to 180 W/mK, from 90 W/mK to 170 W/mK, from 100 W/mK to 160 w/mK, from 110 W/mK to 150 W/mK, or from 120 W/mK to 140 W/mK. In terms of upper limits, the thermal conductivity may be less than 220 W/mK, e.g., less than 210 W/mK, less than 200 W/mK, less than 190 W/mK, less than 180 W/mK, less than 170 W/mK, less than 160 W/mK, less than 150 W/mK, or less than 140 W/mK. In terms of lower limits, the thermal conductivity may be greater than 45 W/mK, e.g., greater than 50 W/mK, greater than 60 W/mK, greater than 70 W/mK, greater than 80 W/mK, greater than 90 W/mK, greater than 100 W/mK, greater than 110 W/mK, greater than 120 W/mK, or greater than 130 W/mK.

The coefficient of thermal expansion (CTE) of the multilayer composite may range from 12 ppm/°C to 17 ppm/°C, e.g., from 12.5 ppm/° °C to 16.5 ppm/°C, from 13 ppm/°C to 16 ppm/°C, from 13.5 ppm/°C to 15.5 ppm/°C, or from 14 ppm/° °C to 15 ppm/°C. In terms of upper limits, the CTE of the multilayer composite may be less than 17 ppm/°C, e.g., less than 16.5 ppm/°C, less than 16 ppm/°C, less than 15.5 ppm/°C, less than 15 ppm/°C, or less than 14.5 ppm/°C. In terms of lower limits, the CTE of the multilayer composite may be greater than 12 ppm/°C, e.g., greater than 12.5 ppm/°C, greater than 13 ppm/°C, greater than 13.5 ppm/°C, or greater than 14 ppm/°C.

The density of the multilayer composite may range from 8.0 g/cm³ to 10 g/cm³, e.g., from 8.1 g/cm³ to 9.9 g/cm³, from 8.2 g/cm³ to 9.8 g/cm³, from 8.3 g/cm³ to 9.7 g/cm³, from 8.4 g/cm³ to 9.6 g/cm³, from 8.5 g/cm³ to 9.5 g/cm³, from 8.5 g/cm³ to 9.4 g/cm³, from 8.6 g/cm³ to 9.3 g/cm³, from 8.7 g/cm³ to 9.3 g/cm³, from 8.8 g/cm³ to 9.2 g/cm³, or from 8.9 g/cm³ to 9.1 g/cm³. In terms of upper limits, the density of the multilayer composite may be less than 10 g/cm³, e.g., less than 9.9 g/cm³, less than 9.8 g/cm³, less than 9.7 g/cm³, less than 9.6 g/cm³, less than 9.5 g/cm³, less than 9.4 g/cm³, less than 9.3 g/cm³, less than 9.2 g/cm³, less than 9.1 g/cm³, or less than 9.0 g/cm³. In terms of lower limits, the density of the multilayer composite may be greater than 8.0 g/cm³, e.g., greater than 8.1 g/cm³, greater than 8.2 g/cm³, greater than 8.3 g/cm³, greater than 8.4 g/cm³, greater than 8.5 g/cm³, greater than 8.6 g/cm³, greater than 8.7 g/cm³, greater than 8.8 g/cm³, or greater than 8.9 g/cm³.

### Battery Pack Connector Tabs

Conventional materials used for connections between individual batteries in battery packs are generally nickel-based, such as metallic nickel strips. While nickel may display some desirable properties, such as suitability for resistance welding and good corrosion resistance, its expense and potential toxicity may make it less desirable to use. Furthermore, the use of nickel-based materials in higher power applications may result in degradation of battery performance and safety due to resistive heating.

The metallic laminate composites of the present disclosure may be particularly suitable for use as connector tabs in battery packs, for example. The multilayer laminate composites of the present disclosure display higher electrical conductivity in comparison to nickel, for example, which may be particularly advantageous in high power applications. It is desirable for portable power battery packs to display the lowest possible electrical resistance between cells to minimize energy losses and permit higher peak currents. It is also desirable that the mechanical connections between cells is able to withstand multiple drops, tool vibration, impact and temperature cycling. The materials used should be weldable using minimum weld energy to avoid overheating a cell's internal separator material. The materials used should be economical without sacrificing performance.

Specifically, the multilayer metallic laminate compositions of the present disclosure display a conductivity that is significantly higher than nickel. The increased conductivity may improve battery pack life while providing higher peak battery current when required.

The multilayer metallic laminate compositions of the present disclosure are suitable for use as connector tabs for lithium ion batteries, nickel metal hydride batteries, and alkaline batteries, for example.

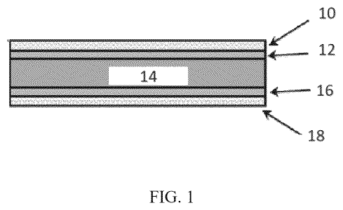

As shown in FIG. 1, the first layer 10 may be an external layer. The second layer 12 may be sandwiched between the first layer 10 and the third layer 14. The second layer may be bonded to both the first layer 10 and the third layer 14. The third layer 14 may be sandwiched between the second layer 12 and the fourth layer 16. In addition to being bonded to the second layer 12, the third layer 14 may be bonded to the fourth layer 16. The fourth layer 16 may be sandwiched between the third layer 14 and the fifth layer 18. In addition to being bonded to the third layer 14, the fourth layer may be bonded to the fifth layer 18.

### EXAMPLES

### Examples 1-8

Fifteen exemplary multilayer laminate compositions (Examples 1-8 and Comparative Examples A-G), each comprising five layers, were evaluated. Specifically, the first and fifth layers of Examples 1-4 and Comparative Example A were a copper alloy comprising 90% copper, the second and fourth layer comprised stainless steel, and the third layer comprised copper. The first and fifth layers of Examples 5-8 and Comparative Example B were a copper alloy comprising 70% copper, the second and fourth layer comprised stainless steel, and the third layer comprised copper. Finally, in Comparative Examples C-G, the first and fifth layers comprised nickel (Ni), the second and fourth layers comprised stainless steel (SS) and the third layer comprised copper (Cu). The volume percentages for the respective layers (based on the total volume of the composition) are shown below in Table 1. As disclosed herein, the working examples employed greater volume percentages for the second layer (greater than 7 vol %).

TABLE 1

| | | | Layer 2 (%) | Layer 3 (%) | Layer 4 (%) | | |
|---|---|---|---|---|---|---|---|
| | Layer 1 (%) | | SS | Cu | SS | Layer 5 (%) | |
| Example 1 | 0.8 | (Cu) | 9.2 | 80.0 | 9.2 | 0.8 | (Cu) |
| Example 2 | 1.5 | (Cu) | 18.5 | 60.0 | 18.5 | 1.5 | (Cu) |
| Example 3 | 10.0 | (Cu) | 20.0 | 40.0 | 20.0 | 10.0 | (Cu) |
| Example 4 | 5.0 | (Cu) | 25.0 | 40.0 | 25.0 | 5.0 | (Cu) |
| Example 5 | 0.8 | (Cu) | 9.2 | 80.0 | 9.2 | 0.8 | (Cu) |
| Example 6 | 1.5 | (Cu) | 18.5 | 60.0 | 18.5 | 1.5 | (Cu) |
| Example 7 | 10.0 | (Cu) | 20.0 | 40.0 | 20.0 | 10.0 | (Cu) |
| Example 8 | 5.0 | (Cu) | 25.0 | 40.0 | 25.0 | 5.0 | (Cu) |
| Comp. Ex. A | 5.0 | (Cu) | 5.0 | 80.0 | 5.0 | 5.0 | (Cu) |
| Comp. Ex. B | 5.0 | (Cu) | 5.0 | 80.0 | 5.0 | 5.0 | (Cu) |
| Comp. Ex. C | 0.8 | (Ni) | 9.2 | 80.0 | 9.2 | 0.8 | (Ni) |
| Comp. Ex. D | 1.5 | (Ni) | 18.5 | 60.0 | 18.5 | 1.5 | (Ni) |
| Comp. Ex. E | 10.0 | (Ni) | 20.0 | 40.0 | 20.0 | 10.0 | (Ni) |
| Comp. Ex. F | 5.0 | (Ni) | 5.0 | 80.0 | 5.0 | 5.0 | (Ni) |
| Comp. Ex. G | 5.0 | (Ni) | 25.0 | 40.0 | 25.0 | 5.0 | (Ni) |

For each example, tensile modulus (TM), flexural modulus (FM), yield strength (YS), electrical conductivity (EC), thermal conductivity (TC), coefficient of thermal expansion (CTE), and density (p) were determined for annealed samples. The results are shown below in Table 2.

TABLE 2

| | YS | TM | FM | EC | TC | CTE | ρ |
|---|---|---|---|---|---|---|---|
| | (MPa) | (GPa) | (GPa) | (% IACS) | (W/m °K) | (ppm/°C) | (g/cm³) |
| Example 1 | 68.3 | 132.8 | 154.8 | 81.5 | 212.6 | 15.2 | 8.72 |
| Example 2 | 103.9 | 148.4 | 176.7 | 61.9 | 104.6 | 13.7 | 8.50 |
| Example 3 | 145.0 | 154.4 | 164.4 | 43.3 | 55.1 | 13.5 | 8.46 |
| Example 4 | 156.9 | 160.7 | 177.8 | 42.7 | 51.7 | 12.9 | 8.35 |
| Example 5 | 69.4 | 133.0 | 155.4 | 80.6 | 210.3 | 14.7 | 8.72 |
| Example 6 | 106.0 | 148.9 | 177.9 | 61.2 | 102.9 | 13.4 | 8.50 |
| Example 7 | 153.0 | 157.2 | 171.1 | 42.0 | 49.8 | 13.2 | 8.46 |
| Example 8 | 162.3 | 162.0 | 181.6 | 41.9 | 48.6 | 12.7 | 8.35 |
| Comp. Ex. A | 62.1 | 127.6 | 140.8 | 82.0 | 216.1 | 15.9 | 8.82 |
| Comp. Ex. B | 63.8 | 128.9 | 144.5 | 80.7 | 211.6 | 15.3 | 8.82 |
| Comp. Ex. C | 62.7 | 132.6 | 154.9 | 81.5 | 210.8 | 16.9 | 8.74 |
| Comp. Ex. D | 72.1 | 148.0 | 177.9 | 62.0 | 102.3 | 16.9 | 8.54 |
| Comp. Ex. E | 79.0 | 165.5 | 194.9 | 45.0 | 68.6 | 16.3 | 8.50 |
| Comp. Ex. F | 64.0 | 133.8 | 158.0 | 82.8 | 223.9 | 16.5 | 8.83 |
| Comp. Ex. G | 77.8 | 164.1 | 191.9 | 43.4 | 56.0 | 16.7 | 8.40 |

As shown in Table 2, Examples 1-8 unexpectedly provide for significant improvements in yield strength. All of the Examples demonstrated over 68 MPa yield strength performance, while those Examples in which the outer layers comprised greater than 0.9 vol % of the laminate composite demonstrated even higher yield strength, e.g., well over 80 MPa. In comparison, the Comparative Examples averaged approximately 68 MPa, and none achieved a yield strength as high as 80 MPa. Importantly, none of the other mechanical performance features were compromised for the aforementioned improvements in yield strength.

Notably, the compositions disclosed herein demonstrate significant improvements in yield strength over the Comparative Examples even when not completely annealed. Specifically, as shown in Table 3, the Examples perform significantly better at ¼ hardness (¼H), ½ hardness (½H), and ¾ hardness (¾H).

TABLE 3
Yield Strength MPa

| | ¼ H | ½ H | ¾ H |
|---|---|---|---|
| Example 1 | 299.7 | 345.9 | 449.6 |
| Example 2 | 381.7 | 483.5 | 572.6 |
| Example 3 | 430.7 | 525.5 | 624.5 |
| Example 4 | 414.2 | 524.6 | 621.3 |
| Example 5 | 297.1 | 342.8 | 445.6 |
| Example 6 | 379.4 | 480.6 | 569.1 |
| Example 7 | 365.6 | 528.9 | 606.6 |
| Example 8 | 387.9 | 528.7 | 626.1 |
| Comp. Ex. A | 272.6 | 314.6 | 409.0 |
| Comp. Ex. B | 276.3 | 318.8 | 414.4 |
| Comp. Ex. C | 232.3 | 309.7 | 361.3 |
| Comp. Ex. D | 266.8 | 355.8 | 415.1 |
| Comp. Ex. E | 292.4 | 389.9 | 454.8 |
| Comp. Ex. F | 236.9 | 315.9 | 368.6 |
| Comp. Ex. G | 287.9 | 383.9 | 447.9 |

As shown above, the Examples significantly outperform those compositions in which the outer skin comprises nickel (Comp. Ex. C-G). Surprisingly, the Examples also outperform compositions in which the second layer comprises less than 7 vol % of the entire laminate composite (Comp. Ex. A and B).

### Solderability

Four multilayer laminate composites as shown in Table 1 were tested to determine solderability using the “dip and look” test, in which a sample was first cleaned and then dipped into a tin solder. The performance was assessed on a pass/fail basis, in which pass indicates that the solder appears smooth and continuous, without any breaks or irregularities in texture.

TABLE 4

| | Layer | Layer | Layer | Layer | Layer | |
|---|---|---|---|---|---|---|
| | 1 | 2 | 3 | 4 | 5 | Result |
| Ex. 1 | 90% Cu | SS | Cu | SS | 90% Cu | Pass |
| Ex. 2 | 90% Cu | SS | Cu | SS | 90% Cu | Pass |
| Ex. 5 | 70% Cu | SS | Cu | SS | 70% Cu | Pass |
| Comp. | Ni | SS | Cu | SS | Ni | Pass |
| Ex. D | | | | | | |

Thus, the multilayer laminate composites disclosed herein provide desirable solderability while offering significant improvements in yield strength. In contrast, the Comparative Examples, while performing well with regard to solderability, were unable to demonstrate superior performance for the synergistic combination of yield strength and solderability.

### EMBODIMENTS

As used below, any reference to a series of embodiments is to be understood as a reference to each of those embodiments disjunctively (e.g., “Embodiments 1-4” is to be understood as “Embodiments 1, 2, 3, or 4”).

Embodiment 1: A metallic laminate composite comprising: a first layer comprising a copper-containing compound; a second layer selected from steel or stainless steel; a third layer selected from copper or copper alloys; an optional fourth layer selected from steel or stainless steel; and an optional fifth layer comprising a copper-containing compound, wherein the composite demonstrates a conductivity ranging from 40% IACS to 82% IACS, as determined by ASTM E1004.

Embodiment 2: The metallic laminate composite of Embodiment 1, wherein the first layer has a conductivity less than 10% IACS.

Embodiment 3: The metallic laminate composite of Embodiment 1 or Embodiment 2, wherein the metal laminate demonstrates excellent corrosion resistance, as determined via SAE/USCAR2 5.6.2 and ASTM B117.

Embodiment 4: The metallic laminate composite of any of Embodiments 1-3, wherein the copper-containing compound comprises copper or a copper alloy or a combination thereof.

Embodiment 5: The metallic laminate composite of any of Embodiments 1-4, wherein the copper-containing compound comprises a copper-nickel alloy.

Embodiment 6: The metallic laminate composite of Embodiment 5, wherein the copper-nickel alloy comprises from 60 wt. % to 95 wt. % copper and from 5 wt. % to 40 wt. % nickel.

Embodiment 7: The metallic laminate composite of Embodiment 6, wherein the copper-nickel alloy comprises greater than 5 wt. % and less than 35 wt. % nickel.

Embodiment 8: The metallic laminate composite of any of Embodiments 1-7, wherein: the first layer comprises 0.9 vol % to 10 vol % of the laminate composite; the second layer comprises 7 vol % to 25 vol % of the laminate composite; the third layer comprises 40 vol % to 80 vol % of the laminate composite; the fourth comprises 7 vol % to 25 vol % of the laminate composite; and/or the fifth layer comprises 0.9 vol % to 10 vol % of the laminate composite.

Embodiment 9: The metallic laminate composite of any of Embodiments 1-8, wherein the first and fifth layers are copper alloys.

Embodiment 10: The metallic laminate composite of any of Embodiments 1-9, wherein the composite demonstrates a tensile strength ranging from 350 MPa to 420 MPa.

Embodiment 11: The metallic laminate composite of any of Embodiments 1-10, wherein the composite demonstrates a yield strength ranging from 280 MPa to 400 MPa.

Embodiment 12: The metallic laminate composite of any of Embodiments 1-11, wherein the composite demonstrates a flexural modulus ranging from 140 GPa to 182 GPa.

Embodiment 13: The metallic laminate composite of any of Embodiments 1-12, wherein the composite demonstrates an elastic modulus ranging from 120 GPa to 160 GPa.

Embodiment 14: A connector tab for a pack of lithium ion batteries comprising a metallic laminate composite, wherein the metallic laminate composite comprises: a first layer comprising a copper-containing compound; a second layer selected from steel or stainless steel; a third layer selected from copper or copper alloys; an optional fourth layer selected from steel or stainless steel; and an optional fifth layer comprising a copper-containing compound, wherein the composite demonstrates a conductivity ranging from 40% IACS to 82% IACS as measured according to ASTM E1004.

Embodiment 15: The connecter tab of Examiner 14, wherein the first and fifth layers comprise a copper-nickel alloy, comprising from 60 wt. % to 95 wt. % copper and from 5 wt. % to 40 wt. % nickel.

Embodiment 16: A metallic laminate composite comprising: a first layer comprising a copper-containing compound; a second layer comprising steel or stainless steel; a third layer selected from copper or copper alloys; an optional fourth layer selected from steel or stainless steel; and an optional fifth layer comprising a copper-containing compound; wherein the first layer comprises greater than 0.9 vol % of the metallic laminate composite; the second layer comprises at least 7 vol % of the metallic laminate composite; wherein the composite demonstrates a yield strength greater than 80 MPa; and wherein the metallic laminate composite passes the Dip and Look solderability test, the test comprising the steps of cleaning a sample of the composite, dipping the cleaned sample in a solder composition, and evaluating the smoothness and continuity of the solder on the sample.

Embodiment 17: The metallic laminate composite of Embodiment 16, wherein the composite demonstrates a conductivity ranging from 40% IACS to 82% IACS, as determined by ASTM E1004.

Embodiment 18: The metallic laminate composite of either Embodiment 16 or Embodiment 17, wherein the copper-containing compound comprises copper or a copper alloy or a combination thereof.

Embodiment 19: The metallic laminate composite of any of Embodiments 16-18, wherein the copper-containing compound comprises a copper-nickel alloy.

Embodiment 20: The metallic laminate composite of Embodiment 19, wherein the copper-nickel alloy comprises from 65 wt. % to 95 wt. % copper and from 5 wt. % to 35 wt. % nickel.

Embodiment 21: The metallic laminate composite of any of Embodiments 16-20, wherein: the first layer comprises from 0.9 vol % to 15 vol % of the metallic laminate composite; the second layer comprises from 7 vol % to 25 vol % of the metallic laminate composite; the third layer comprises 35 vol % to 85 vol % of the metallic laminate composite; the fourth layer comprises 7 vol % to 25 vol % of the metallic laminate composite; and/or the fifth layer comprises 0.9 vol % to 15 vol % of the metallic laminate composite.

Embodiment 22: The metallic laminate composite of any of Embodiments 16-21, wherein the first and fifth layers are copper alloys.

Embodiment 23: The metallic laminate composite of any of Embodiments 16-22, wherein the composite demonstrates a tensile modulus ranging from 120 GPa to 180 GPa.

Embodiment 24: The metallic laminate composite of any of Embodiments 16-23, wherein the composite demonstrates a flexural modulus greater than 135 GPa.

Embodiment 25: The metallic laminate composite of any of Embodiments 16-24, wherein the composite demonstrates a thermal conductivity of the multilayer composite ranging from 50 W/mK to 220 W/mK.

Embodiment 26: A connector tab for a pack of lithium ion batteries comprising a metallic laminate composite, wherein the metallic laminate composite comprises: a first layer comprising a copper-containing compound; a second layer selected from steel or stainless steel; a third layer selected from copper or copper alloys; an optional fourth layer selected from steel or stainless steel; and an optional fifth layer comprising a copper-containing compound; wherein the composite demonstrates a conductivity ranging from 40% IACS to 82% IACS as measured according to ASTM E1004; wherein the first layer comprises greater than 0.9 vol % of the metallic laminate composite; and wherein the second layer comprises greater than 7 vol % of the metallic laminate composite.

Embodiment 27: The connecter tab of Embodiment 26, wherein the first and fifth layers comprise a copper-nickel alloy, comprising from 65 wt. % copper to 95 wt. % copper and from 5 wt. % to 35 wt. % nickel.

Embodiment 28: A metallic laminate composite comprising: a first layer comprising a copper-containing compound in an amount from 0.7 vol % to 1.4 vol % of the metallic laminate; a second layer comprising steel or stainless steel in an amount greater than 7 vol % of the metallic laminate; a third layer selected from copper or copper alloys; an optional fourth layer selected from steel or stainless steel; and an optional fifth layer comprising a copper-containing compound; wherein the composite demonstrates a yield strength greater than 62 MPa; and wherein the metallic laminate composite passes the Dip and Look solderability test, the test comprising the steps of cleaning a sample of the composite, dipping the cleaned sample in a solder composition, and evaluating the smoothness and continuity of the solder on the sample.

Embodiment 29: The metallic laminate composite of Embodiment 28, wherein the copper-containing compound comprises copper or a copper alloy or a combination thereof.

Embodiment 30: The metallic laminate composite of Embodiment 28 or Embodiment 29, wherein the copper-containing compound comprises a copper-nickel alloy.

Embodiment 31: The metallic laminate composite of Embodiment 30: wherein the copper-nickel alloy comprises from 65 wt. % to 95 wt. % copper and from 5 wt. % to 35 wt. % nickel.

Embodiment 32: A metallic laminate composite comprising: a first layer comprising a copper-containing compound in an amount greater than 0.9 vol % of the metallic laminate; a second layer comprising steel or stainless steel in an amount greater than 7 vol % of the metallic laminate; a third layer selected from copper or copper alloys; an optional fourth layer selected from steel or stainless steel; and an optional fifth layer comprising a copper-containing compound; wherein the composite demonstrates a yield strength greater than 293 MPa when annealed to ¼ H, or greater than 390 MPa when annealed to ½ H, or greater than 456 MPa when annealed to ¾ H; wherein the metallic laminate composite passes the Dip and Look solderability test, the test comprising the steps of cleaning a sample of the composite, dipping the cleaned sample in a solder composition, and evaluating the smoothness and continuity of the solder on the sample.

Embodiment 33: A metallic laminate composite comprising: a first layer comprising a copper-containing compound in an amount from 0.7 vol % to 1.4 vol % of the metallic laminate; a second layer comprising steel or stainless steel in an amount greater than 7 vol % of the metallic laminate; a third layer selected from copper or copper alloys; an optional fourth layer selected from steel or stainless steel; and an optional fifth layer comprising a copper-containing compound; wherein the composite demonstrates a yield strength greater than 62 MPa; and wherein the metallic laminate composite passes the Dip and Look solderability test, the test comprising the steps of cleaning a sample of the composite, dipping the cleaned sample in a solder composition, and evaluating the smoothness and continuity of the solder on the sample.

Embodiment 34: A metallic laminate composite comprising: a first layer comprising a copper-containing compound in an amount from 0.7 vol % to 1.4 vol % of the metallic laminate; a second layer comprising steel or stainless steel in an amount greater than 7 vol % of the metallic laminate; a third layer selected from copper or copper alloys; an optional fourth layer selected from steel or stainless steel; and an optional fifth layer comprising a copper-containing compound; wherein the composite demonstrates a yield strength greater than 233 MPa when annealed to ¼ H, or greater than 310 MPa when annealed to ½ H, or greater than 362 MPa when annealed to ¾ H; and wherein the metallic laminate composite passes the Dip and Look solderability test, the test comprising the steps of cleaning a sample of the composite, dipping the cleaned sample in a solder composition, and evaluating the smoothness and continuity of the solder on the sample.

1. A metallic laminate composite comprising:
a first layer comprising a copper-containing compound in an amount greater than 0.9 vol % of the metallic laminate;
a second layer comprising steel or stainless steel in an amount greater than 7 vol % of the metallic laminate;
a third layer selected from copper or copper alloys;
an optional fourth layer selected from steel or stainless steel; and
an optional fifth layer comprising a copper-containing compound;
wherein the composite demonstrates a yield strength greater than 80 MPa; and
wherein the metallic laminate composite passes the Dip and Look solderability test, the test comprising the steps of cleaning a sample of the composite, dipping the cleaned sample in a solder composition, and evaluating the smoothness and continuity of the solder on the sample.

2. The metallic laminate composite of claim 1, wherein the composite demonstrates a conductivity ranging from 40% IACS to 82% IACS, as determined by ASTM E1004.

3. The metallic laminate composite of claim 1, wherein the copper-containing compound comprises copper or a copper alloy comprising a copper-nickel alloy or a combination thereof.

4. The metallic laminate composite of claim 4, wherein the copper-nickel alloy comprises from 65 wt. % to 95 wt. % copper and from 5 wt. % to 35 wt. % nickel.

5. The metallic laminate composite of claim 1, wherein:
the first layer comprises from 0.9 vol % to 15 vol % of the metallic laminate composite;
the second layer comprises from 7 vol % to 25 vol % of the metallic laminate composite;
the third layer comprises 35 vol % to 85 vol % of the metallic laminate composite;
the fourth layer comprises 7 vol % to 25 vol % of the metallic laminate composite; and/or
the fifth layer comprises 0.9 vol % to 15 vol % of the metallic laminate composite.

6. The metallic laminate composite of claim 1, wherein the first and fifth layers are copper alloys.

7. The metallic laminate composite of claim 1, wherein the composite demonstrates a tensile modulus ranging from 120 GPa to 180 GPa and/or a flexural modulus greater than 135 GPa and/or a thermal conductivity ranging from 45 W/mK to 220 W/mK.

8. A connector tab for a pack of lithium ion batteries comprising the metallic laminate composite of claim 1 and a
wherein the composite demonstrates a conductivity ranging from 40% IACS to 82% IACS as measured according to ASTM E1004;
wherein the first layer comprises greater than 0.9 vol % of the metallic laminate composite; and
wherein the second layer comprises greater than 7 vol % of the metallic laminate composite.

9. The connecter tab of claim 8, wherein the first and fifth layers comprise a copper-nickel alloy, comprising from 65 wt. % copper to 95 wt. % copper and from 5 wt. % to 35 wt. % nickel.

10. A metallic laminate composite comprising:
a first layer comprising a copper-containing compound in an amount from 0.7 vol % to 1.4 vol % of the metallic laminate;
a second layer comprising steel or stainless steel in an amount greater than 7 vol % of the metallic laminate;
a third layer selected from copper or copper alloys;
an optional fourth layer selected from steel or stainless steel; and
an optional fifth layer comprising a copper-containing compound;
wherein the composite demonstrates a yield strength greater than 62 MPa; and
wherein the metallic laminate composite passes the Dip and Look solderability test, the test comprising the steps of cleaning a sample of the composite, dipping the cleaned sample in a solder composition, and evaluating the smoothness and continuity of the solder on the sample.

11. The metallic laminate composite of claim 10, wherein the copper-containing compound comprises copper or a copper alloy comprising a copper-nickel alloy or a combination thereof.

12. The metallic laminate composite of claim 11, wherein the copper-nickel alloy comprises from 65 wt. % to 95 wt. % copper and from 5 wt. % to 35 wt. % nickel.

13. A metallic laminate composite comprising:
a first layer comprising a copper-containing compound in an amount greater than 0.9 vol % of the metallic laminate;
a second layer comprising steel or stainless steel in an amount greater than 7 vol % of the metallic laminate;
a third layer selected from copper or copper alloys;
an optional fourth layer selected from steel or stainless steel; and
an optional fifth layer comprising a copper-containing compound;
wherein the composite demonstrates a yield strength greater than 293 MPa when annealed to ¼ H, or greater than 390 MPa when annealed to ½ H, or greater than 456 MPa when annealed to ¾ H;
wherein the metallic laminate composite passes the Dip and Look solderability test, the test comprising the steps of cleaning a sample of the composite, dipping the cleaned sample in a solder composition, and evaluating the smoothness and continuity of the solder on the sample.

14. (canceled)

15. The metallic laminate composite of claim 10,
wherein the composite demonstrates a yield strength greater than 233 MPa when annealed to ¼ H, or greater than 310 MPa when annealed to ½ H, or greater than 362 MPa when annealed to ¾ H.

16. The metallic laminate composite of claim 10, wherein the composite demonstrates a conductivity ranging from 40% IACS to 82% IACS, as determined by ASTM E1004.

17. The metallic laminate composite of claim 10, wherein the copper-containing compound comprises copper or a copper alloy comprising a copper-nickel alloy or a combination thereof.

18. The metallic laminate composite of claim 17, wherein the copper-containing compound comprises a copper alloy and wherein the copper-nickel alloy comprises from 65 wt. % to 95 wt. % copper and from 5 wt. % to 35 wt. % nickel.

19. The metallic laminate composite of claim 13, wherein the composite demonstrates a conductivity ranging from 40% IACS to 82% IACS, as determined by ASTM E1004.

20. The metallic laminate composite of claim 13, wherein the copper-containing compound comprises copper or a copper alloy comprising a copper-nickel alloy or a combination thereof.

21. The metallic laminate composite of claim 20, wherein the copper-containing compound comprises a copper alloy and wherein the copper-nickel alloy comprises from 65 wt. % to 95 wt. % copper and from 5 wt. % to 35 wt. % nickel.
